(19) United States
(12) Patent Application Publication
(10) Pub. No.: US 2022/0232778 A1
(43) Pub. Date: Jul. 28, 2022

(54) FEEDING MECHANISM FOR CONTINUOUS SQUARE BALER

(71) Applicant: Charles Siebenga, Bozeman, MT (US)

(72) Inventor: Charles Siebenga, Bozeman, MT (US)

(21) Appl. No.: 17/649,017

(22) Filed: Jan. 26, 2022

Related U.S. Application Data
(60) Provisional application No. 63/141,616, filed on Jan. 26, 2021.

(51) Int. Cl. A01F 15/10; A01F 15/18

(52) U.S. Cl. CPC A01F 15/10; A01F 2015/186; A01F 15/18

(57) ABSTRACT

A feeding mechanism for a crop baler having a leaf forming chute, quick feeding mechanism, hay guides, hay gates, hay leaf divider drum and a control mechanism to stop and start the rotation of the divider drum. The leaf forming chute guides the crop from the packing crank to the middle of the bale chamber. The quick feeding device moves hay from the divider drum to the compression area above or below the compression roller. A control devise stops and starts the rotation of the divider drum causing an equal amount of hay to be placed in the top of the bale as compared to the bottom of the bale. The same control devise to stop the rotation of the divider drum and to stop the movement of hay to the compression area during the tying cycle.

### CROSS REFERENCE TO RELATED APPLICATION

This application claims the benefit of U.S. Provisional Application 63/141,616, which was filed on Jan. 26, 2021, the disclosure of which is hereby incorporated by reference.

### BACKGROUND OF THE INVENTION

### 1. Field of the Invention

The present invention pertains to a baler for collecting and baling crops. More particularly, the present invention pertains to a feed mechanism for a baler for collecting and baling crops.

### 2. Description of the Prior Art

The operation of the baler described in U.S. Pat. No. 9,591,807 B 1 proved the quick feed device could not be operated efficiently at a high speed and was difficult to make in comparison to the new quick feed design. The leaf cutter was also difficult to operate at a high speed and was difficult to maintain as compared to a divider drum. The hay guides could not be operated at a high speed being positioned by the compression roller. Therefore, there was a need to reduce the impact caused by the starting and stopping due to the contact and movement of the compression roller.

### SUMMARY OF THE INVENTION

A quick feed mechanism has been created to perform the same function as the previous quick feed mechanism as disclosed in U.S. Pat. No. 9,591,807. The new quick feed mechanism only uses pivoting mechanisms and no sliding mechanisms. A crank is located below the gathering chute. The distal ends of the crank are pivotally mounted to arms which extend upward from the pivot toward the gathering chute and downwards from the pivot towards the ground. The upward extension of the arms are connected by a beam which houses elongated teeth to engage the crop in the leaf forming chute to move it to the compression area as the crank is rotated. The bottom extension is pivotally connected to a link. The opposing end of the link is pivotally connected to the frame. The distance of the crank pivot on the arm to the bottom extension pivot being somewhat longer than the crank arm. This will cause the elongated teeth to engage the crop in the leaf forming chute and then move the crop to the compression area and then disengage the elongated teeth from the leaf forming chute and then return the elongated teeth to the front of chute to reengage the crop as the crank rotates.

A dividing drum is provided to segment the continuous leaf in the leaf forming chute. The dividing drum having three rows of elongated teeth. Each row containing enough teeth to move the crop forward and to stop the crop from moving forward when the drum is not rotated. The three rows are spaced in thirds around the drum. Each third space wide enough to hold a half a leaf to be compressed into the top or bottom of the bale. The drum is rotated in synchronicity with the quick feed device to allow a segment of crop between two rows of teeth to be moved to the compression area for each stroke of the quick feed device.

The dividing drum is rotated at a continuous speed equal to one third the speed of the quick feed crank. The dividing drum has a clutching mechanism attached to its drive shaft. This clutching mechanism disengages the rotation of the dividing drum at the exact time a row of teeth are full engaged in the leaf forming chute. The clutch then engages a third rotation later. This stoppage causes the quick feed devise to not place a segment of crop below or above the compression cylinder depending on the time the divider drum stops. The divider drum stops the feeding of a segment of hay during the tying cycle to allow the needles to retract without hay being compress into the bottom of the bale. The engagement and disengagement of the dividing drum controlled by a computer program as it reads signals received from rotating star wheels.

Hay guides have been created to guide the hay into the bale chamber as the compression roller moves up and down. There is one hay guide for the upward motion of the compression roller and one hay guide for the downward motion of the compression roller. The hay guides are rotated around a point to allow the guides to clear the pivot of the hay gates and move away from the compression roller as it moves up and down. The hay guides return to the guiding position once the compression roller is move out of the way. The hay guides are connected to each other in such a way as to allow the opposing guide to remain in place to guide the hay into the bale chamber as the compression roller moves up or down. The hay guides motion is controlled by a cam which forces the hay guides to move up and down at the precise time needed. The curve which guides the crop into the bale chamber is modified to allow the hay guide to be moved upward as the compression roller passes the midpoint of its stroke. This allows for the gradual acceleration of the hay guides while maintaining a small gap between the hay guides and the leading edge of the compression roller.

Air actuators are placed between the frame and hay guide arms and hay gate arms to create enough force on the cam followers to maintain the contact between the cam followers and the cams. The pressure in these can be increased as the speed is increased to maintain the contact between the cams and the cam followers.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 is an isometric view of the left side according to an embodiment of the present invention hereof;

FIG. 2 is an isometric view of the right side of the baler;

FIG. 3 is an isometric view with the left side panel removed from the front of baler;

FIG. 4 is a side view of the left side of baler with most stationary parts removed from the left side to reveal the moving parts in their position when the compression roller is down;

FIG. 5 is a side view of the left side of the baler with all stationary parts removed from the left side to reveal the moving parts in their position when the compression roller is approximately one quarter up;

FIG. 6 is a side view of the left side of the baler with all stationary parts removed from the left side to reveal the moving parts in their position when the compression roller is approximately one half up;

FIG. 7 is a side view of the left side of the baler with all stationary parts removed from the left side to reveal the moving parts in their position when the compression roller is approximately three quarters up;

FIG. 8 is a side view of the left side of the baler with all stationary parts removed from the left side to reveal the moving parts in their position when the compression roller is all the way up;

FIG. 9 is the clutching mechanism for the divider drum and the divider drum;

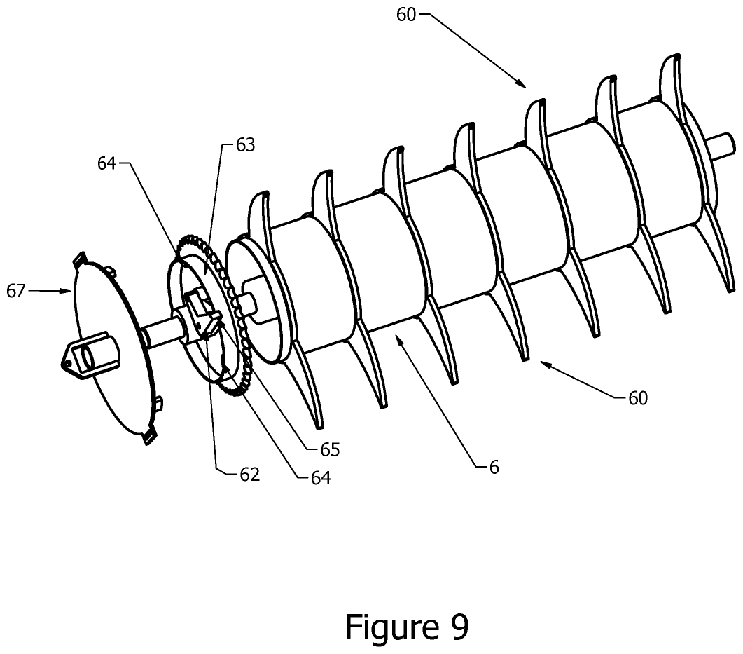

FIG. 10 is an isometric of the quick feed mechanism;

FIG. 11 is an isometric of the upper and lower hay guides;

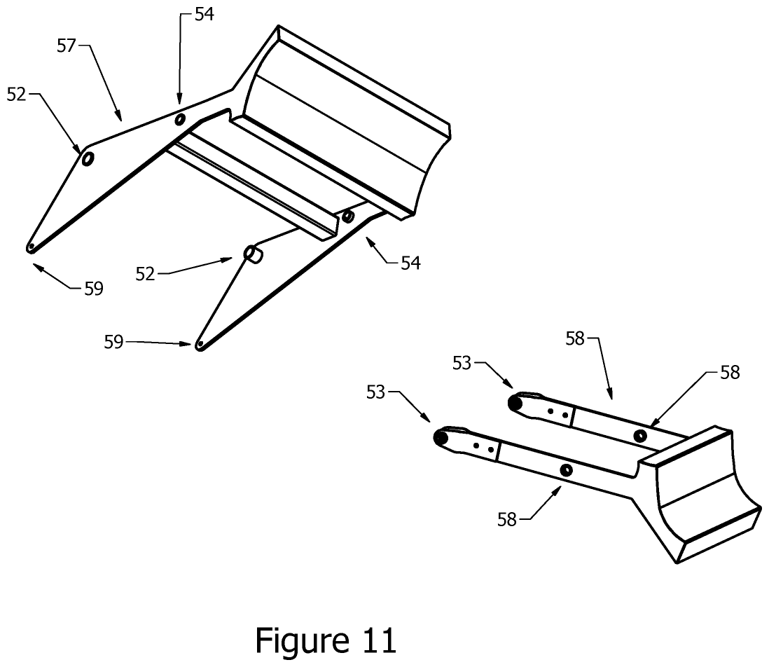

FIG. 12 is an isometric of the bottom right side of baler; and

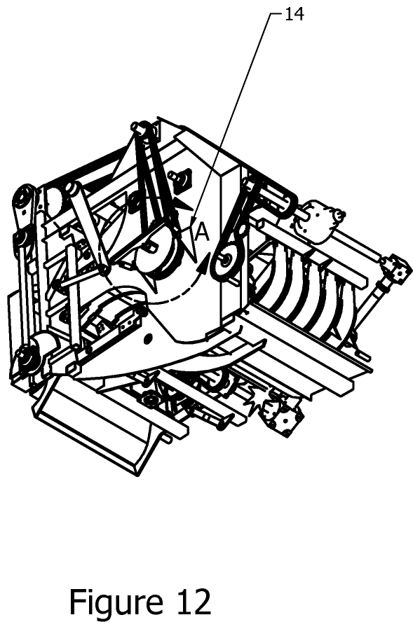

FIG. 13 is a detail of the divider drum clutch.

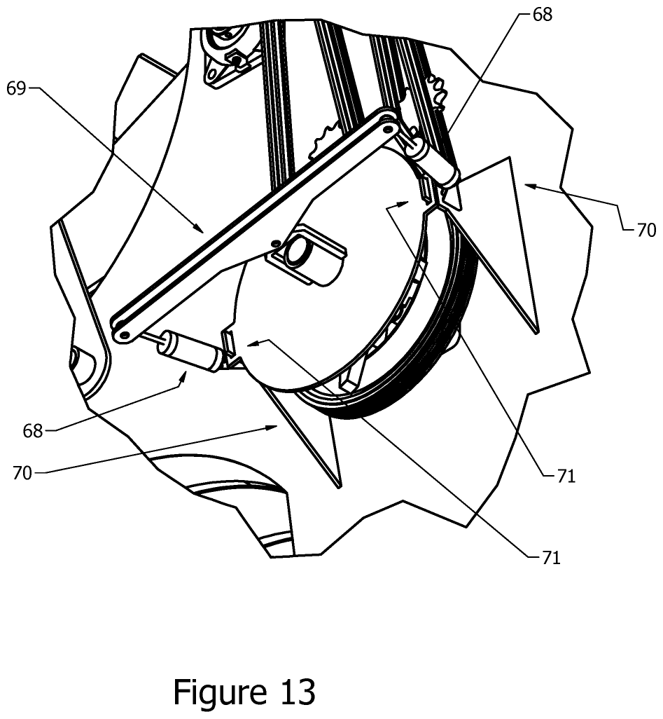

### DETAILED DESCRIPTION OF THE PREFERRED EMBODIMENT

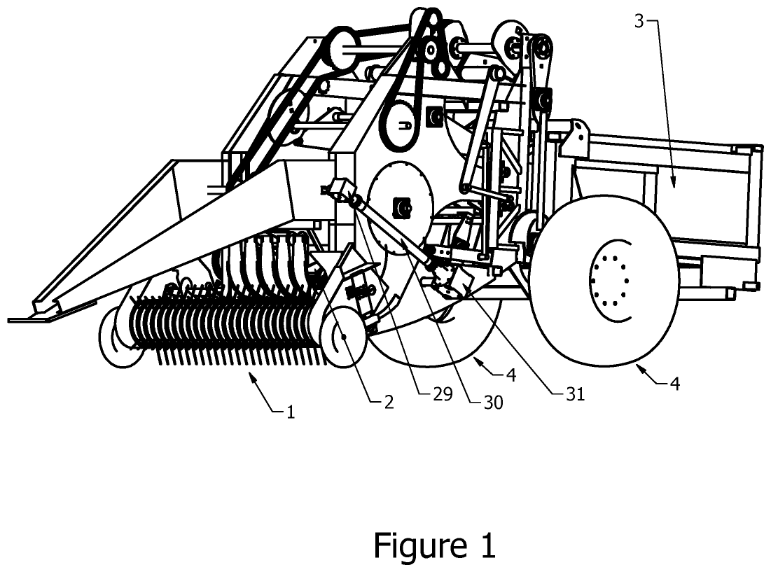

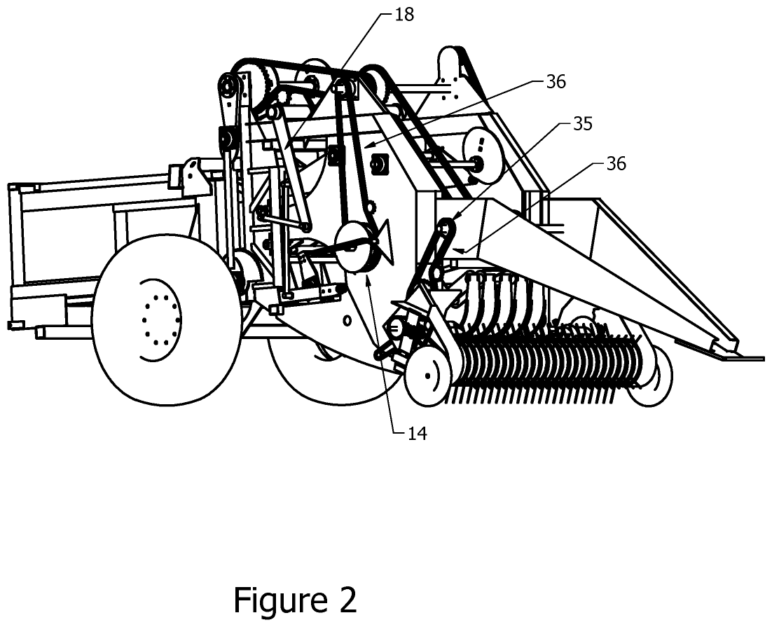

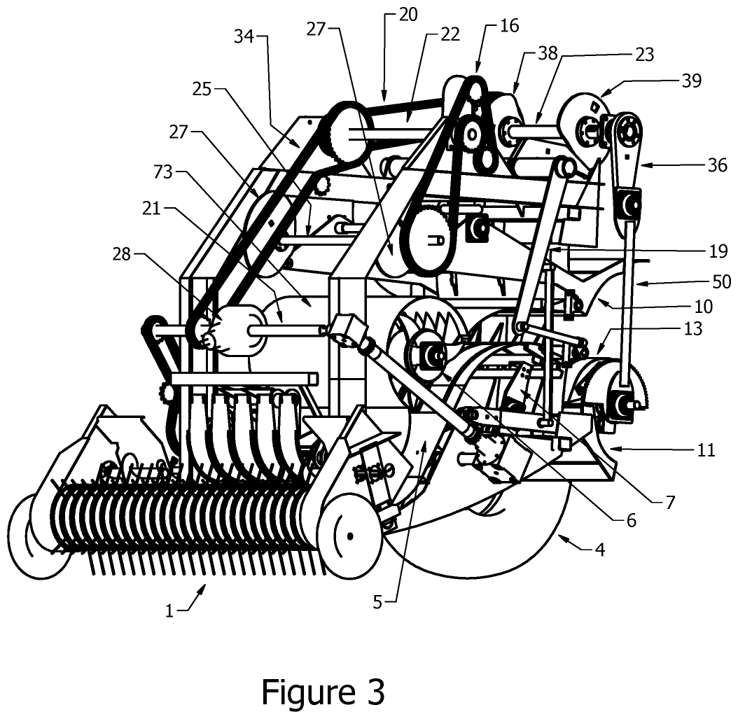

In accordance with the present invention, FIGS. 1 and 2 and 3 show the arrangement of the drive shafts, drive chains and gear boxes to operate the mechanisms. Power from the tractor is connected to input gear box 28. Input gear box 28 takes the inline power and transfers the power to shaft 21 at a speed which the components of the baler will function at a maximum speed with minimum repair. Quick feed gear box 29 takes the power from shaft 21 and transfers the power to shaft 30 at the same rotational speed as shaft 21. Quick feed gear box 31 takes the power from shaft 30 and transfers the power to quick feed shaft 32 with half the rotational speed of quick feed shaft 30 and in the opposite rotating direction of shaft 21. The quick feed drive chain 15 transfers the power of quick feed drive shaft 32 to quick feed crank shaft 26 with the same rotational speed as quick feed drive shaft 32. Quick feed crank shaft 26 drives the quick feed crank arms 33 which operate the quick feed mechanism.

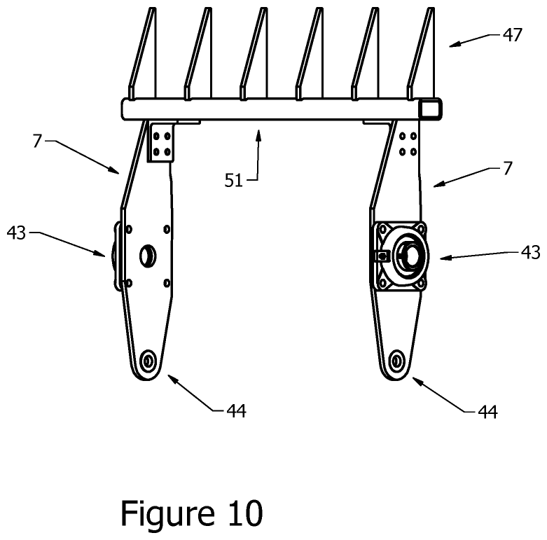

The quick feed mechanism is in FIG. 10. The quick feed mechanism is moved by arms 7 rotated about point 43 by the quick feed crank shaft arms 33. Pivot point 44 is connected to link 45. The opposite end of link 45 is pivotally connected to the frame. The quick feed arms 7 are bolted to the quick feed arms connecting member 51. Protruding from the arms connecting member 51 are elongated teeth 46. Teeth 46 protrude through slots in the leaf forming chute 5 to move the crop from the dividing drum 6 to the compression area. The distance between pivot 43 and 44 being longer than the quick feed crank arms 33 to create the motion needed to move the crop from the dividing drum 6 to the compression area and return without engaging the teeth in the leaf forming chute.

Power is transferred from input drive shaft 21 to middle drive shaft 22 with roller chain 34. The speed of middle drive shaft 22 is reduce to half the speed of input drive shaft 21. Input drive shaft 21 has sprocket 35 to drive the packer crank 2 and the pickup 1 through roller chain 36. Middle drive shaft 22 transfers power to compression roller crank shaft 23 through roller chain 20. The speed of compression roller crank shaft 23 is half the speed of middle drive shaft 22. Compression roller crank shaft 23 rotates the compression roller crank arms 36 which move the compression roller 13 up and down through connecting links 50. Middle drive shaft 22 turns the dividing drum 6 through roller chain 37 and divider drum clutch 14. The dividing drum 6 rotates at one third the speed of middle drive shaft 22. Middle drive shaft 22 turns hay guides cams driving shaft 25 in the opposite direction and at half the speed of Middle drive shaft 22 transferring the power through roller chain 16. Hay guides cams driving shaft 25 turns the hay guides cams 27 to move the hay guides 10 & 11 up and down through cams 27.

Compression roller crank shaft 23 turns cams 38, 39. Cam 38 opens and closes the upper hay gate through linkage 18. Cam 39 opens and closes lower hay gate through linkage 19. The cam followers are held to the cams by air bags 40, 41.

The upper hay guide is pivotally connected to shaft 24 at pivot point 52. The lower hay guide is pivotally connected to the frame at pivot point 53. The upper and lower hay guides are pivotally connect to each other at pivots point 54 and 55 by connecting links 17. One connecting link on the right side and one on the left side of the hay guides. Cam followers are place at pivot points 59 to engage the hay guide cams 27. The hay guide cams 27 are identical and raise and lower the hay guides 57, 58 to maintain a small gap between the leading edge of the compression roller and the curved shape of the hay guides 57, 58 to force hay into the bale chamber 3 as compression roller moves up and down.

The divider drum 6 is almost as wide as the bale chamber 3 and large enough in diameter to hold a half a leaf in between the two rows of teeth 60. Teeth 60 are protruding from the drum in three rows one third the diameter from each other and the teeth 60 are spaced apart to allow the quick feed teeth 47 to go between each set of teeth 60 on the row. The teeth 60 are long enough to fully engage the crop in the leaf forming chute 5. The divider drum 6 is placed in the baler far enough from the compression roller 13 to allow for a half a leaf to be delivered to the compression area by the quick feed mechanism 7 without pushing hay into the compression roller 13 or out of the baler.

The divider drum shaft 61 having a pivoting lever 62 attached near the end to engage the clutch rotating drum 63 driven by chain 37. The pivoting lever 62 being spring loaded to force it away from shaft 61. The lever 62 being able to engage the stops 64 on the rotating drum 63 to force shaft 61 to rotate as long as the pivoting lever 62 is against one of three stops placed in thirds inside rotating drum 63. The pivoting lever 62 having member 65 protruding outside the rotating drum 63 long enough to engage one of the three tabs 67 spaced in thirds around the outside of the sliding stop mechanism 66. When the sliding stop mechanism 66 is moved towards the rotating drum one of the tabs 67 will engage the pivoting lever member 65 and release it from the rotating drum stop 64. This will cause the rotation of shaft 61 to stop because the pivoting lever 62 is against the tab 67 of the sliding stop mechanism 66. When the sliding stop mechanism 66 is move away from the rotating drum 63 the pivoting lever 62 is then allowed to engage the next stop on the rotating drum. The spacing of the tabs 67 and 64 are orientated to stop the movement of the divider drum 6 when a row of teeth 60 are fully engaged in the leaf form chute 30.

The sliding stop mechanism 66 is moved in and out by the linear air actuating cylinders 68 through linkage 69. Tabs 70 slide in the slots 71 in the slider stop. This keeps the slider stop from rotating on the divider drum shaft 72.

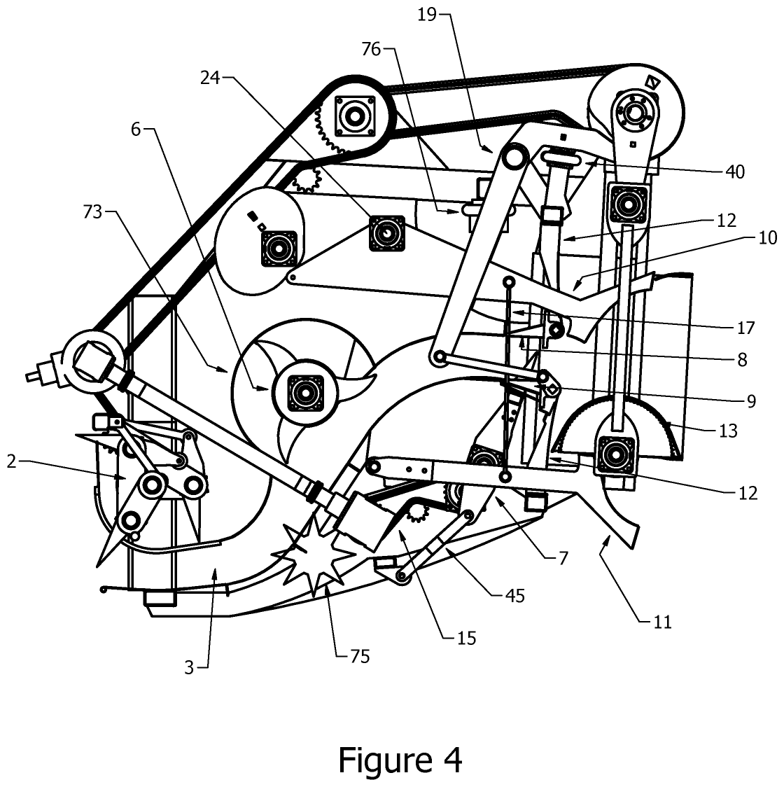

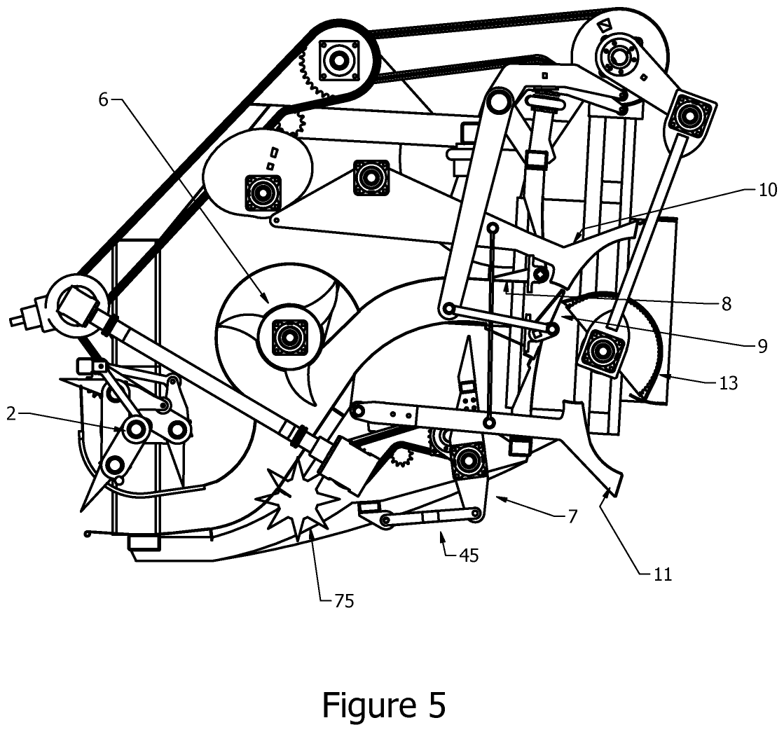

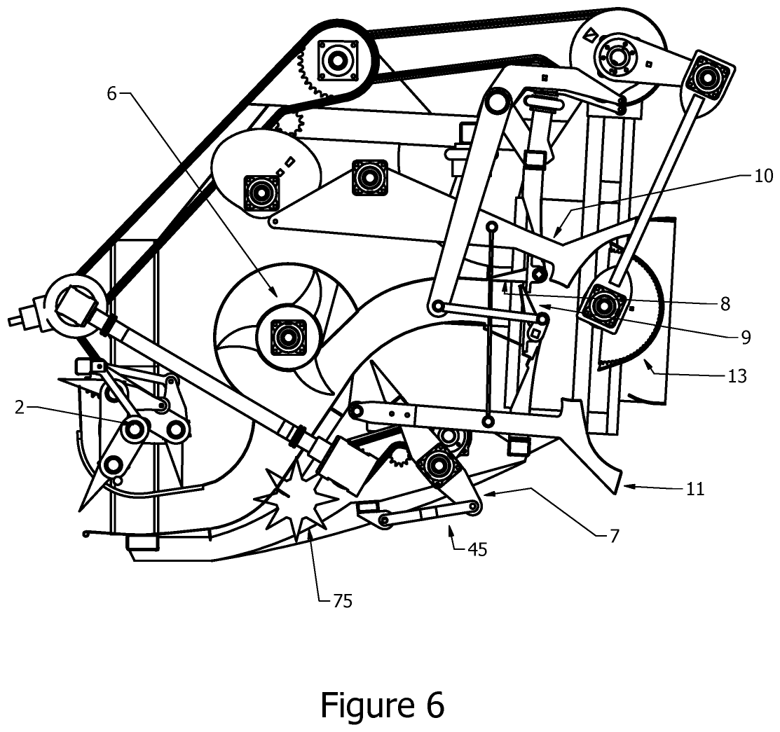

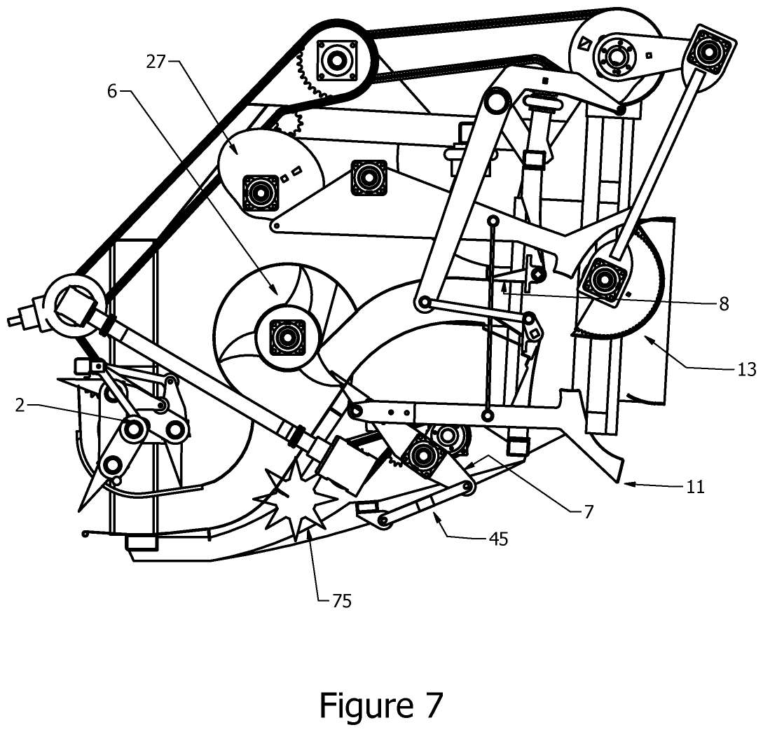

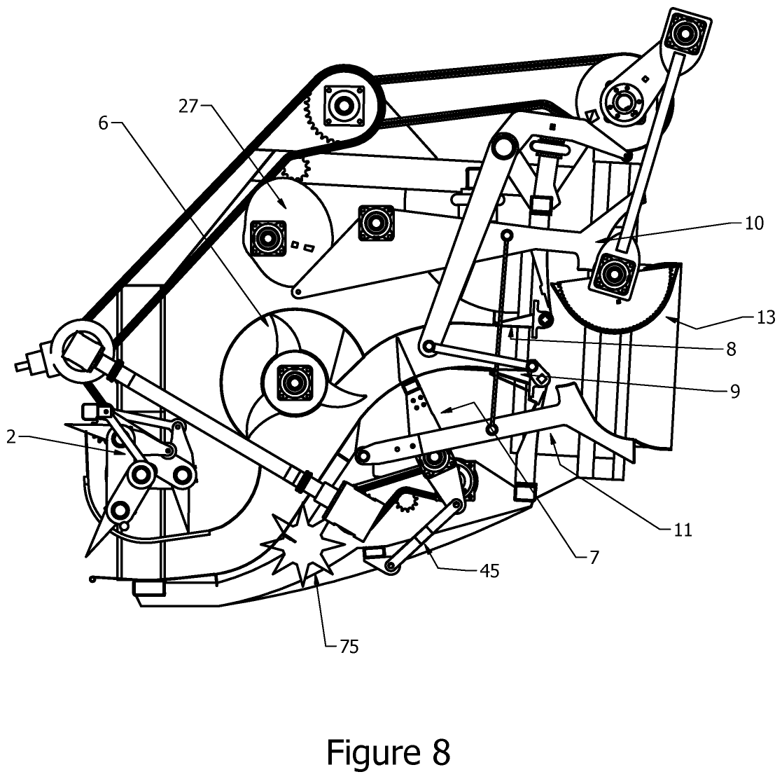

FIGS. 4-8 show how the preferred embodiments need to be synchronized to move a half a leaf into the compression area and allow the compression roller to compress the crop into the bale chamber without any crop being ejected out of the baler. FIGS. 4-8 show the motion as the compression roller is moving up. The reverse operation occurs when the compression roller moves down.

Leaf forming chute 5 is as wide as the bale chamber and curved to move hay from the packer crank 2 to the center of the bale chamber 3. The height of the leaf forming chute to be approximately equal to the length of the elongated teeth 47 on the quick feed mechanism 7. The leaf forming chute 5 also having cylinder 73 to enclose the divider drum 6. The cylinder to be open the width of the bale chamber to allow the drum teeth 60 to engage the crop in the chute 5 and move the crop forward. The leaf forming chute 5 to also have tabs 74 to stop the crop from going around the divider drum 6, but forcing the crop to continue to move towards the baler chamber 3. The leaf forming chute 5 to have slots in the bottom of chute 5 to allow for the teeth 47 of the quick feed mechanism 7 to engage the crop and move it from the divider drum 6 to the compression area.

Star wheels 75 are placed in the leaf forming chute 5 to rotate as the crop is moved through the leaf forming chute 5 to the bale chamber 3. A measuring device is placed on the star wheels 75 to send a signal to the computer. The computer than monitors the amount of crop moved through the chute and controls the divider drum clutch to place equal amounts of hay in the top and bottom of the bale.

It should be understood that the foregoing description is only illustrative of the aspects of the disclosed embodiments. Various alternatives and modifications can be devised by those skilled in the art without departing from the aspects of the disclosed embodiments. Accordingly, the aspects of the disclosed embodiments are intended to embrace all such alternatives, modifications, and variances that fall within the scope of the appended claims. Further, the mere fact that different features are recited in mutually different dependent or independent claims does not indicate that a combination of these features cannot be advantageously used, such as a combination remaining within the scope of the aspects of the disclosed embodiments.

What is claimed is:

1. A square baler comprising:
a wheeled frame having a front end and a rear end, the front end having a hitch adapted for connecting the baler to a powered wheeled vehicle such that the vehicle is capable of pulling the baler through a field surface filled with crop;
the front end further comprising an inclined surface having a lower edge located near the field surface such that as the baler is pulled over the field surface the crop is forced up the inclined surface;
a leaf forming chute mounted above the wheeled frame rearward of the inclined surface and forward of a bale chamber, the leaf forming chute including a gate at a rearward end of the leaf forming chamber, the gate being selectively opened to permit crop to pass into the bale chamber from the leaf forming chamber, or selectively closed to not permit crop to pass into the bale chamber from the leaf forming chamber;
a semi cylindrical compression roller slidably and rotatably mounted on a vertical mount structure located at the front of the bale chamber, the roller having a curved face with an arc length which is substantially as long as the height of the bale chamber;
the roller being slidable between a low position near a bottom of the bale chamber, a high position near a top of the bale chamber, and a middle position located halfway between the high position and the low position and about level with a midpoint of the height of the of bale chamber;
the roller being rotatable such that when it is located in the low position, the curved face is directed substantially upward, when it is located in the middle position the curved face is directed substantially rearward, and when it is located in the high position the curved face is directed substantially downward;
whereby as the roller is slid upwardly from the low position toward the high position while the baler is being pulled forward, the curved face rotates from the upward facing direction through the rearward facing direction and to the downward facing direction, and whereby as the roller is slid downwardly from the high position toward the low position while the baler is being pulled forward, the curved face rotates from the downward facing direction through the rearward facing direction and to the upward facing direction;
a feed mechanism adapted for moving piles of crop from the leaf forming chute into the front of the bale chamber;
whereby when the roller is positioned below the middle position, the feed mechanism moves a first pile of crop to a location above the curved face, and then, as the roller moves upwardly, the curved face compresses the first pile of crop rearwardly and upwardly in the bale chamber; and
whereby when the roller is positioned above the middle position, the feed mechanism moves a second pile of crop to a location below the curved face, and then, as the roller moves downwardly, the curved face compresses the second pile of crop rearwardly and downwardly in the bale chamber.
